(19) United States
(12) Patent Application Publication
(10) Pub. No.: US 2011/0305009 A1
(43) Pub. Date: Dec. 15, 2011

(54) VEHICLE BAFFLE WITH SOLAR LAMP

(76) Inventor: Rui-Hong WENG, Taishan Township (TW)

(21) Appl. No.: 12/962,729

(22) Filed: Dec. 8, 2010

(30) Foreign Application Priority Data
Jun. 11, 2010 (TW) 099211246

(51) Int. Cl. F21L 4/08; F21L 4/00

(52) U.S. Cl. 362/183

(57) ABSTRACT

A vehicle baffle with a solar lamp includes a baffle main body, an illuminating module, a solar power supply module, and a switch. The illuminating module is fixed to the baffle main body. The solar power supply module is installed in the baffle main body and is electrically connected to the illuminating module. The switch is electrically connected to the illuminating module and the solar power supply module; it controls the on/off of the illuminating module. The vehicle baffle can act as a fender, and will use solar light to charge when the light is sufficient. The stored solar power can then be supplied to the illuminating module. When the surrounding light is sufficient, the illuminating module will stop illuminating in order to conserve energy.

### BACKGROUND

1. Technical Field

The present invention relates to vehicle parts. More particularly, the present invention relates to a vehicle baffle with a solar lamp.

2. Related Art

As the human civilization develops, vehicles have become an indispensable means of transportation. To enhance safety and minimize the possibility of vehicle-related traffic accidents, the bodies of most contemporary vehicles have lamps for illuminating or warming purposes. These lamps are especially useful when the environments surrounding the vehicles are dim or dark.

However, to illuminate, a vehicle lamp must consume the power stored in a battery on the vehicle and decrease the level of stored power. If the stored power is exhausted, the lamp can no longer operate, and the vehicle might not be able to keep running This is quite dangerous because another vehicle running behind might fail to stop and might collide with the vehicle with no warning/illuminating light.

Furthermore, the vehicle battery might need replacement if it is of low power level or run out of power. This not only increases the maintenance costs, but also might lead to some environmental problems.

### BRIEF SUMMARY

The present invention provides a vehicle baffle with a solar lamp. The vehicle baffle can be installed in the back of a vehicle body. In addition to functioning as a fender, the vehicle baffle can also absorb solar light (when the light is strong enough) to charge a battery. The stored power can then be used to supply a lamp so that the lamp can generate light. Furthermore, when the surrounding light is sufficient, the lamp can stop generating light so as to conserve energy.

To achieve these and other objectives, the invention provides a vehicle-back baffle structure as an embodiment. The vehicle-back baffle structure includes a baffle main body, an illuminating module, a solar power supply module, and a switch. The illuminating module is fixed to the baffle main body. The solar power supply module is installed in the baffle main body and is electrically connected to the illuminating module. The switch is electrically connected to the illuminating module and the solar power supply module, for turning on and turning off the illuminating module.

The solar power supply module includes a control circuit board, a solar panel electrically connected to the control circuit board, and a storage battery electrically connected to the control circuit board.

The vehicle-back baffle structure further includes a charging socket electrically connected to the control circuit board.

The vehicle-back baffle structure has the following advantages.

The vehicle-back baffle structure uses solar energy, which is very environmentally friendly, to charge the solar power supply module when the surrounding light is sufficient in the day time. When the surrounding light is insufficient, the solar power supply module will supply the stored power to the illuminating module. This reduces the burden and waste of changing batteries.

The switch allows a user to turn on/off the illuminating module easily, simply by pressing/switching the switch. This allows the user to stop the illuminating module from running and hence can avoid energy waste.

Furthermore, when the surrounding light is insufficient and the solar power supply module is exhausted, the charging socket allows energy to be supply from outside. As a result, the embodiment has a broad range of applications.

The embodiment is installed in the back of a vehicle body. In addition to functioning as a fender, the embodiment can further emit light backward from the vehicle body, so as to increase safety by giving warning to the people and vehicles behind.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a three-dimensional exploded diagram of a vehicle baffle according to an embodiment of the present invention;

FIG. 2 shows a perspective diagram of the vehicle baffle after combination;

FIG. 3 shows a cross-sectional diagram of the vehicle baffle after combination;

FIG. 4 shows the vehicle baffle installed in vehicle body;

FIG. 5 shows a lamp case of an embodiment of the present invention installed in a baffle main body; and

FIG. 6 shows how the present invention may be applied to a bicycle.

### DETAILED DESCRIPTION

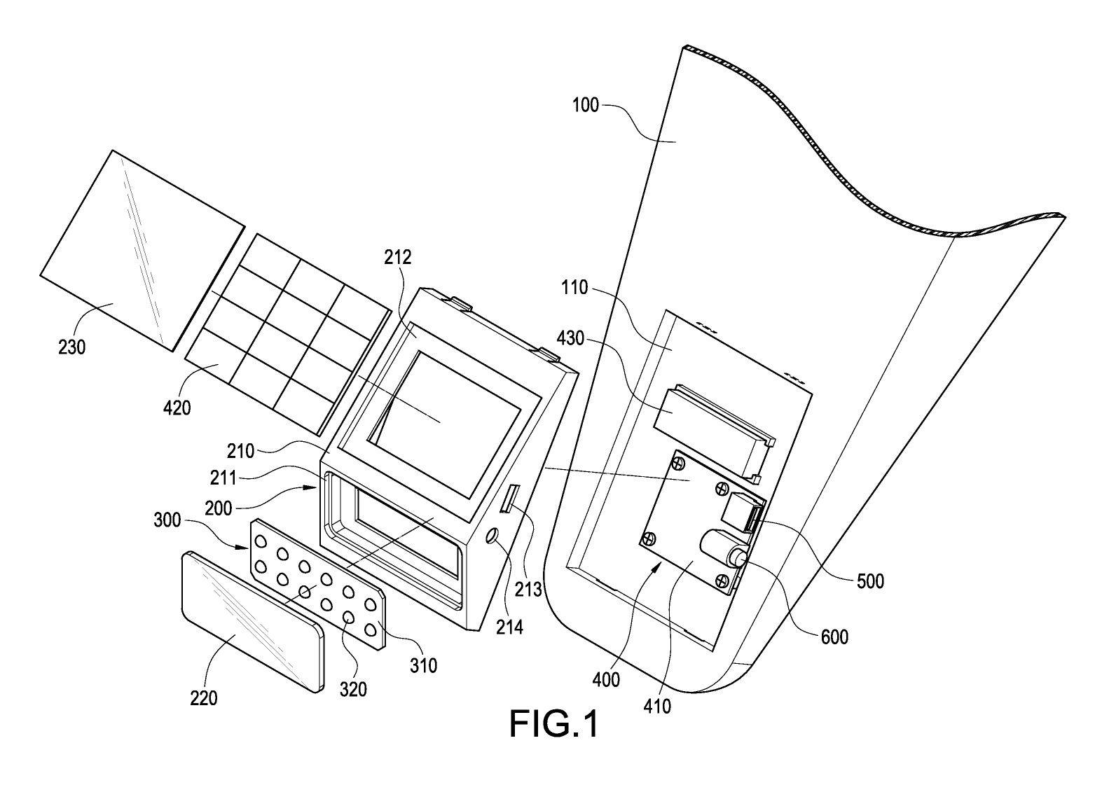

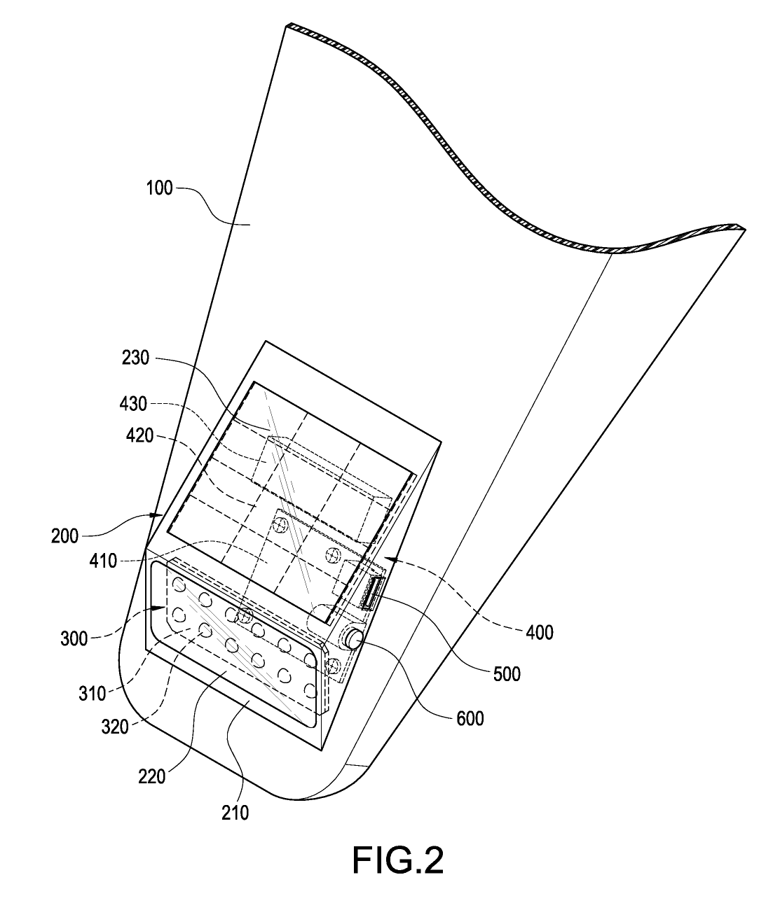

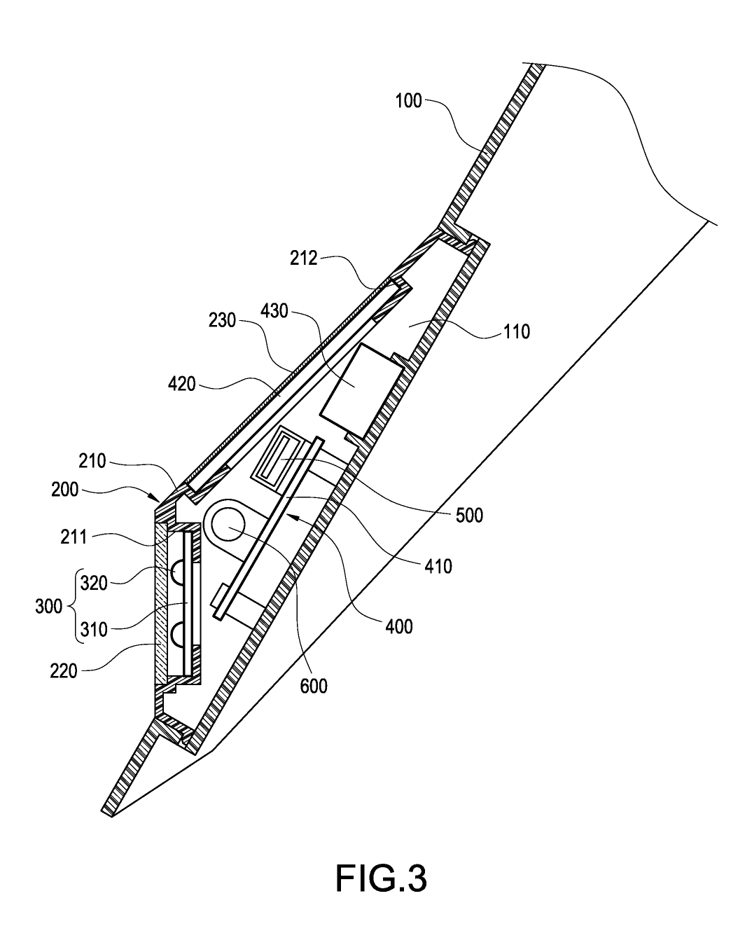

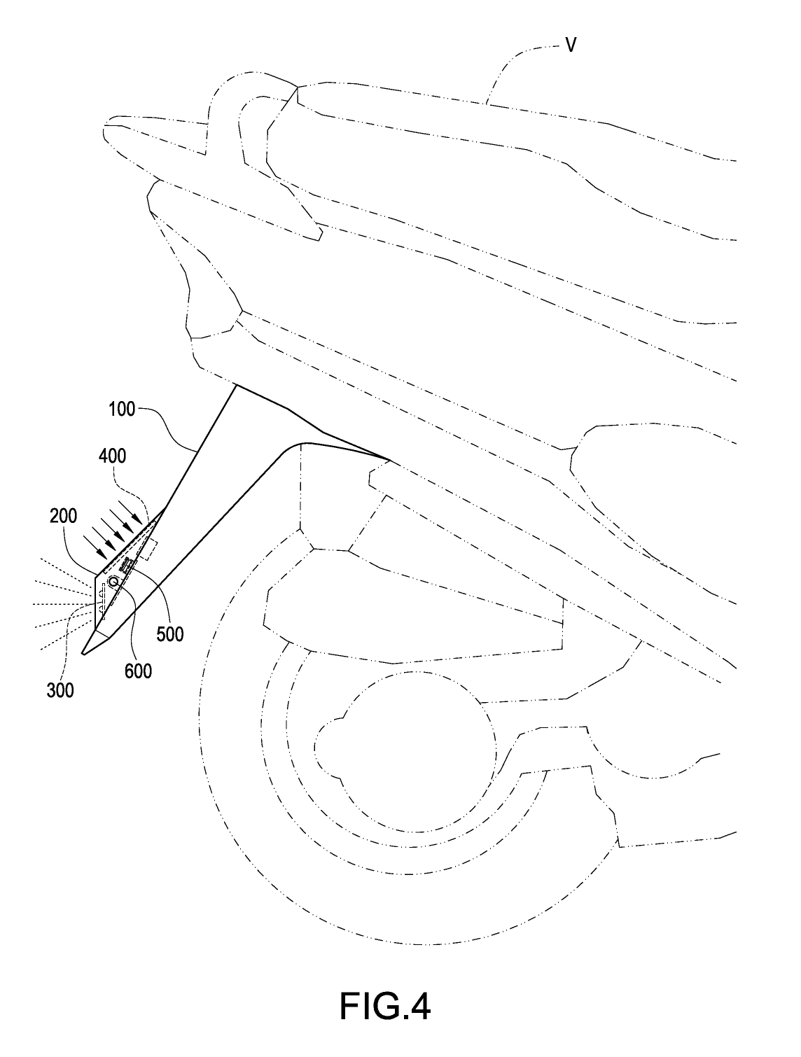

The present invention provides a vehicle baffle with a solar lamp. As shown in FIG. 1 to FIG. 4, the vehicle baffle includes a baffle main body 100, a lamp case 200, an illuminating module 300, a solar power supply module 400, a charging socket 500, and a switch 600.

The baffle main body 100 is installed in the back of a vehicle body V. In this embodiment, the vehicle body V is a motorcycle. The baffle main body 100 is installed in a fender in the end of the motorcycle. The outer surface of the baffle main body 100 has a container trough 110.

The lamp case 200 is installed in the baffle main body 100 and is embedded in the container trough 110. The lamp case 200 includes a housing base 210, a diaphanous protective-cover 220, and a diaphanous protective-plate 230. The housing base 210 is hollow, installed in the baffle main body 100, and embedded in the container trough 110. Furthermore, the inner space of the housing base 210 is connected to the container trough 110.

The housing base 210 has an opening 211, a via hole 212, a perforation 213, and a through hole 214; they interconnect the inner space of the housing base 210 and the container trough 110. The diaphanous protective-cover 220 is embedded in the opening 211; the diaphanous protective-plate 230 is embedded in the via hole 212.

The illuminating module 300 is fixed to the baffle main body 100 and to the interior of the housing base 210 of the lamp case 200. That is, the lamp case 200 allows the illuminating module 300 to be fixed. In other words, the housing base 210 is installed in the baffle main body 100 and allows the illuminating module 300 to be fixed. Specifically, the illuminating module 300 is embedded in the opening 211 and is covered by the diaphanous protective-cover 220. More specifically, the illuminating module 300 includes a conducting circuit board 310 and a plurality of illuminating components 320. The conducting circuit board 310 is embedded in the opening 211. That is, the opening 211 allows the diaphanous protective-cover 220 and the conducting circuit board 310 to be embedded. Each illuminating component 320 is set on the conducting circuit board 310 and is electrically connected to the conducting circuit board 310.

When operating, the light generated by each illuminating component 320 will pass through the diaphanous protective-cover 220 and reach the surrounding area. The diaphanous protective-cover 220 covers the illuminating module 300 and hence protects the conducting circuit board 310 and each illuminating component 320 of the illuminating module 300 from being affected by foreign objects coming from outside.

The solar power supply module 400 is installed in the baffle main body 100 and is fixed to the interior of the housing base 210 of the lamp case 200. That is, the lamp case 200 allows the solar power supply module 400 to be fixed. In other words, the housing base 210 is installed in the baffle main body 100 and allows the solar power supply module 400 to be fixed. Furthermore, the solar power supply module 400 is electrically connected to the illuminating module 300. Specifically, the solar power supply module 400 includes a control circuit board 410, a solar panel 420, and a storage battery 430.

The control circuit board 410 is set in the container trough 110 and fixed to the interior of the housing base 210 of the lamp case 200. The solar panel 420 is electrically connected to the control circuit board 410. The solar panel 420 is embedded in the via hole 212 and is covered by the diaphanous protective-plate 230. More specifically, the via hole 212 allows the diaphanous protective-plate 230 and the solar panel 420 to be embedded. The storage battery 430 is set on the control circuit board 410 and is electrically connected to the control circuit board 410.

The solar panel 420 can absorb the light coming from outside and through the diaphanous protective-plate 230, convert the light into electricity, and store the electricity into the storage battery 430. The diaphanous protective-plate 230 covers the solar power supply module 400 and hence protects the control circuit board 410, the solar panel 420, and the storage battery 430 of the solar power supply module 400 from being affected by foreign objects.

The charging socket 500 is set in the container trough 110 and fixed to the interior of the housing base 210 of the lamp case 200. Specifically, the charging socket 500 is set on the control circuit board 410 and is electrically connected to the control circuit board 410. Furthermore, the charging socket 500 is connected through the perforation 213. In other words, the perforation 213 allows the charging socket 500 to be connected through, so that an outside plug can be connected to the charging socket 500. The outside plug can provide outside power to charge the storage battery 430 through the charging socket 500, so as to make up the power requirements of the rated supply power of the solar panel 420 and the storage battery 430.

The switch 600 is electrically connected to the illuminating module 300 and the solar power supply module 400, so that the switch 600 can control the on/off of the illuminating module 300. Specifically, the switch 600 is set on the control circuit board 410, and is electrically connected to the conducting circuit board 310 and the control circuit board 410. Furthermore, the switch 600 is connected through the through hole 214. In other words, the through hole 214 allows the switch 600 to be connected through.

The storage battery 430 supplies the power required by each illuminating component 320. By pressing/switching the switch 600, a user can turn on the illuminating components 320 to generate light, or to turn off the illuminating components 320 to stop them from generating light.

The present invention uses solar energy, which is very environmentally friendly, to charge the storage battery 430 when the surrounding light is sufficient in the day time. When the surrounding light is insufficient, the storage battery 430 will supply power to the illuminating components 320. This reduces the burden and waste of changing batteries. Furthermore, the switch 600 allows a user to turn on/off the illuminating module 300 easily, simply by pressing/switching the switch 600. This allows the user to stop the illuminating module 300 from running and hence can avoid energy waste. Furthermore, when the surrounding light is insufficient and the storage battery 430 is exhausted, the charging socket 500 can allows energy to be supply from outside. As a result, the embodiment has a broad range of applications.

The embodiment is installed in the back of the vehicle body V. In addition to functioning as a fender, the embodiment can further emit light backward from the vehicle body V, so as to increase safety by giving warning to the people and vehicles behind.

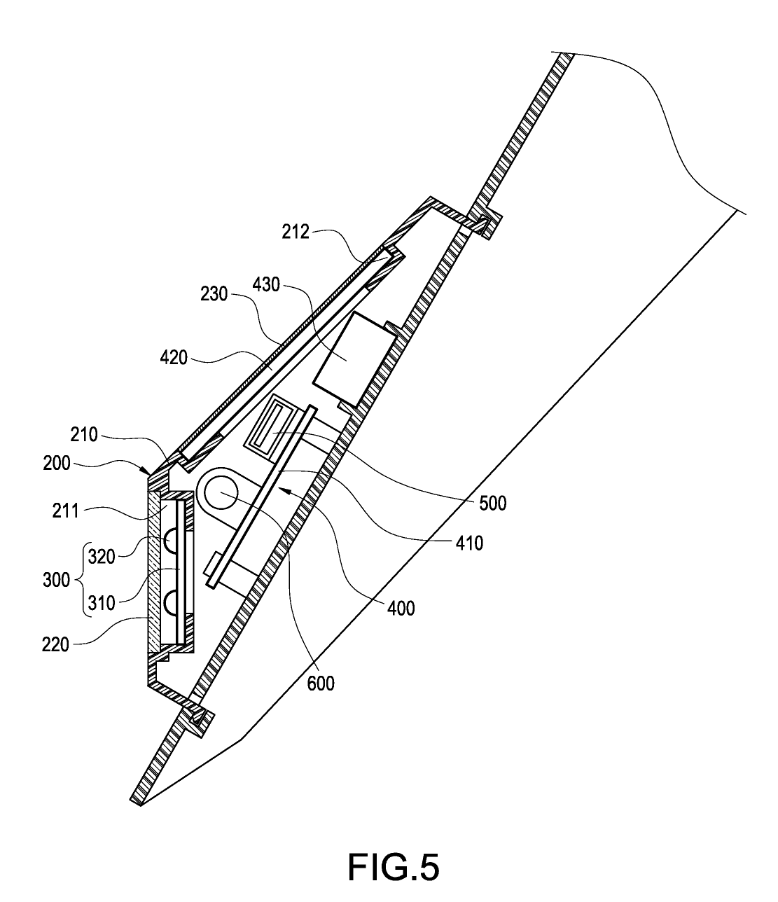

FIG. 5 shows that the lamp case 200 can also be installed on the outer surface of the baffle main body 100.

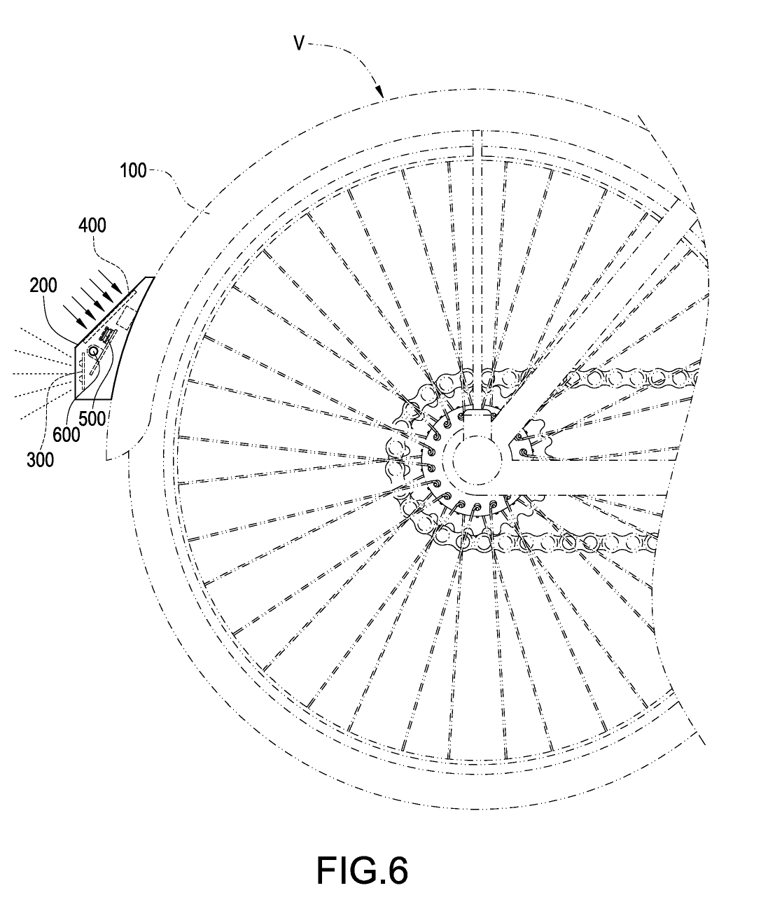

FIG. 6 shows another embodiment where the vehicle body V is a bicycle and the baffle main body 100 is a fender in the back of the bicycle.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A vehicle baffle with a solar lamp, comprising:
a baffle main body;
an illuminating module, fixed to the baffle main body;
a solar power supply module, installed in the baffle main body and electrically connected to the illuminating module; and
a switch, electrically connected to the illuminating module and the solar power supply module, for turning on and turning off the illuminating module.

2. The vehicle baffle of claim 1, further comprising a housing base installed in the baffle main body, the housing base has a through hole for the switch to be connected through.

3. The vehicle baffle of claim 1, wherein the illuminating module comprises a conducting circuit board and a plurality of illuminating components electrically connected to the conducting circuit board.

4. The vehicle baffle of claim 3, wherein the switch is electrically connected to the conducting circuit board.

5. The vehicle baffle of claim 3, further comprising a housing base installed in the baffle main body and for the illuminating module to be fixed to, and a diaphanous protective-cover covering the illuminating module, the housing base having an opening for the diaphanous protective-cover and the conducting circuit board to be embedded in.

6. The vehicle baffle of claim 1, wherein the solar power supply module comprises a control circuit board, a solar panel electrically connected to the control circuit board, and a storage battery electrically connected to the control circuit board.

7. The vehicle baffle of claim 6, further comprising a fixed housing base installed in the baffle main body and allowing the solar power supply module to be fixed to, and a diaphanous protective-plate covering the solar power supply module, the housing base having a via hole allowing the diaphanous protective-plate and the solar panel to be embedded in.

8. The vehicle baffle of claim 6, further comprising a charging socket electrically connected to the control circuit board.

9. The vehicle baffle of claim 8, further comprising a housing base installed in the baffle main body, the housing base having a perforation for the charging socket to be connected through.

10. The vehicle baffle of claim 1, wherein the baffle main body is a fender.
